(19) United States
(12) Patent Application Publication
(10) Pub. No.: US 2014/0351750 A1
(43) Pub. Date: Nov. 27, 2014

(54) METHOD AND SYSTEM FOR OPERATING ELECTRONIC DEVICE

(71) Applicant: COMPAL ELECTRONICS, INC., Taipei City (TW)

(72) Inventors: Ching-Wen SUN, Taipei City (TW); Pin-Yu CHOU, Taipei City (TW); Hsiu-Hang LIN, Taipei City (TW); Ming-Che WENG, Taipei City (TW); Yu-Tzu HSU, Taipei City (TW); Sheng-Jing TANG, Taipei City (TW)

(73) Assignee: COMPAL ELECTRONICS, INC., Taipei City (TW)

(21) Appl. No.: 14/269,202

(22) Filed: May 5, 2014

Related U.S. Application Data
(60) Provisional application No. 61/827,660, filed on May 26, 2013.

(51) Int. Cl. G06F 3/0481

(52) U.S. Cl. CPC G06F 3/04812
USPC 715/803

(57) ABSTRACT

A method for operating an electronic device, in which the electronic device includes a drag sensor, a display unit and a processing unit electrically connected with the drag sensor and the display unit. The method includes: (a) sensing a drag track by utilizing the drag sensor; (b) calculating a drag length of the drag track by utilizing the processing unit; and (c) when the drag length is within a preset range, displaying at least one datum of a first level on the display unit, or otherwise displaying at least one datum of a second level on the display unit.

### RELATED APPLICATIONS

This application claims priority to U.S. Application Ser. No. 61/827,660, filed May 26, 2013, the entirety of which is herein incorporated by reference.

### BACKGROUND

1. Technical Field

The present disclosure relates to a method and a system for operating an electronic device.

2. Description of Related Art

With the development of digital technology, various data are digitalized. Generally, digital data are stored in storage units (for example, a read only memory, a flash memory, a floppy disk, a hard disk drive, a compact disc read only memory (CD-ROM), a USB memory stick or a magnetic storage device), and the storage units are formatted using tree structures such that the digital data are stored in different data levels.

Since the data are stored in tree structures, users have to frequently switch between different directories. For example, when the users would like to view data with higher levels, the users have to repeatedly click the icons of upper-level directories, or repeatedly input the instructions of the upper-level directories. Consequently, the more data levels stored in the storage unit, the more clicks or inputs are needed.

Therefore, how to reduce the clicks or the inputs needed when viewing the data of different levels is a very important issue in this field.

### SUMMARY

In one aspect, the present disclosure is related to a method for operating an electronic device, in which the electronic device includes a drag sensor, a display unit and a processing unit electrically connected with the drag sensor and the display unit. The method includes: (a) sensing a drag track by utilizing the drag sensor; (b) calculate a drag length of the drag track by utilizing the processing unit; and (c) when the drag length is within a preset range, display at least one datum of a first level by utilizing the display unit, or otherwise display at least one datum of a second level by utilizing the display unit.

In another aspect, the present disclosure is related to a system for operating an electronic device, in which the system includes a drag sensor, a display unit, a storage unit storing a plurality of instructions and a processing unit. The processing unit is electrically connected with the drag sensor, the display unit and the storage unit. The processing unit accesses the instructions stored in the storage unit and executes: (a) driving the drag sensor to sense a drag track; (b) calculating a drag length of the drag track; and (c) when the drag length is within a preset range, drive the display unit to display at least one datum of a first level, or otherwise drive the display unit to display at least one datum of a second level.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow chart of a method for operating an electronic device in accordance with one embodiment of the present disclosure;

FIG. 2 is an application of a method for operating an electronic device in accordance with one embodiment of the present disclosure;

FIG. 3A to FIG. 3D are schematic diagram of the switches between a plurality of data in accordance with other embodiments;

FIG. 4 is a schematic diagram of a system for operating an electronic device in accordance with one embodiment of the present disclosure

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

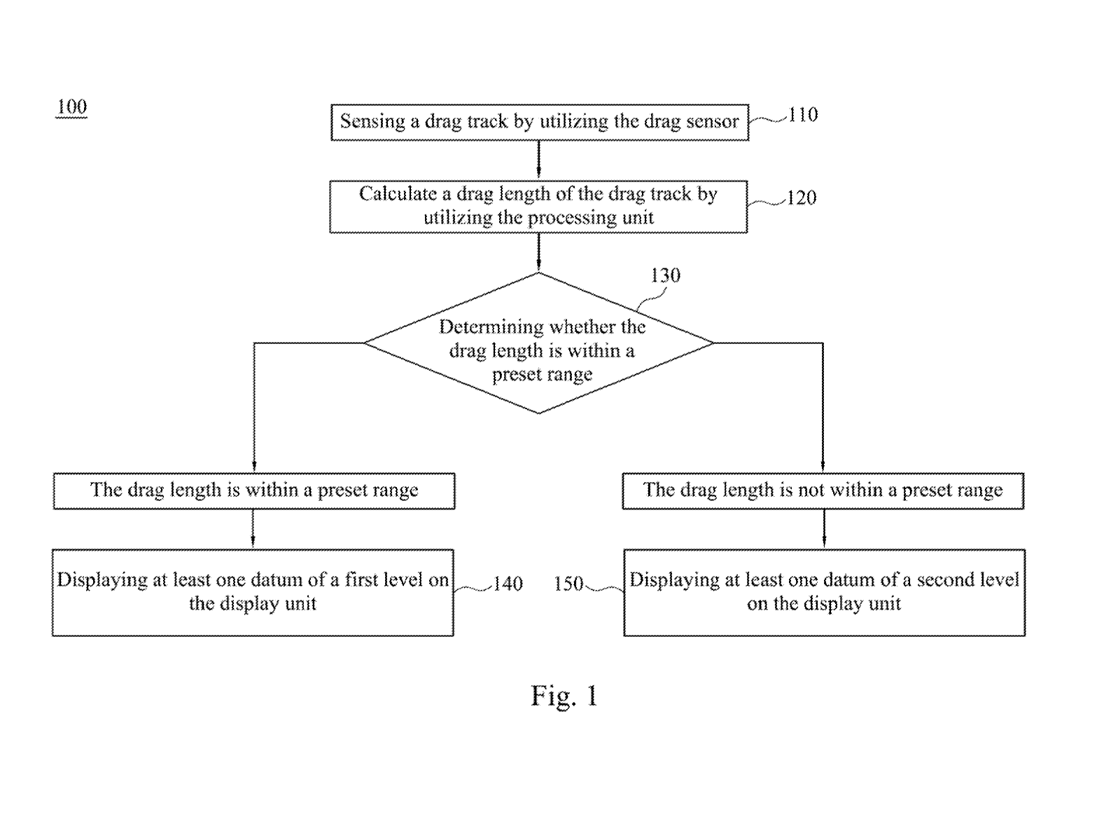

Reference is made first to FIG. 1. FIG. 1 is a flow chart of a method 100 for operating an electronic device in accordance with one embodiment of the present disclosure. In the method 100 for operating the electronic device, data of different levels are provided according to different drag length. The electronic device includes a drag sensor, a display unit and a processing unit electrically connected with the drag sensor and the display unit,

The method 100 for operating the electronic device may take the form of a computer program product stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The method 100 for operating the electronic device includes the following steps.

In step 110, a drag track is sensed by utilizing the drag sensor. The drag sensor can be a mouse, a touch pad, a touch panel, hardware units determining drag gestures of a user (for example, a photography unit or a G-sensor), other input units capable of providing drag functions, or systems capable of detecting or operating drags. In other words, the user can operate the mouse, the touch panel or other input units or systems capable of providing drag functions to do the drag operation such that the drag track can be sensed in step 110.

In step 120, a drag length of the drag track is calculated by utilizing the processing unit, such that in step 130, whether the drag length is within a preset range is determined.

In step 140, when the drag length is within a preset range, at least one datum of a first level is displayed on the display unit.

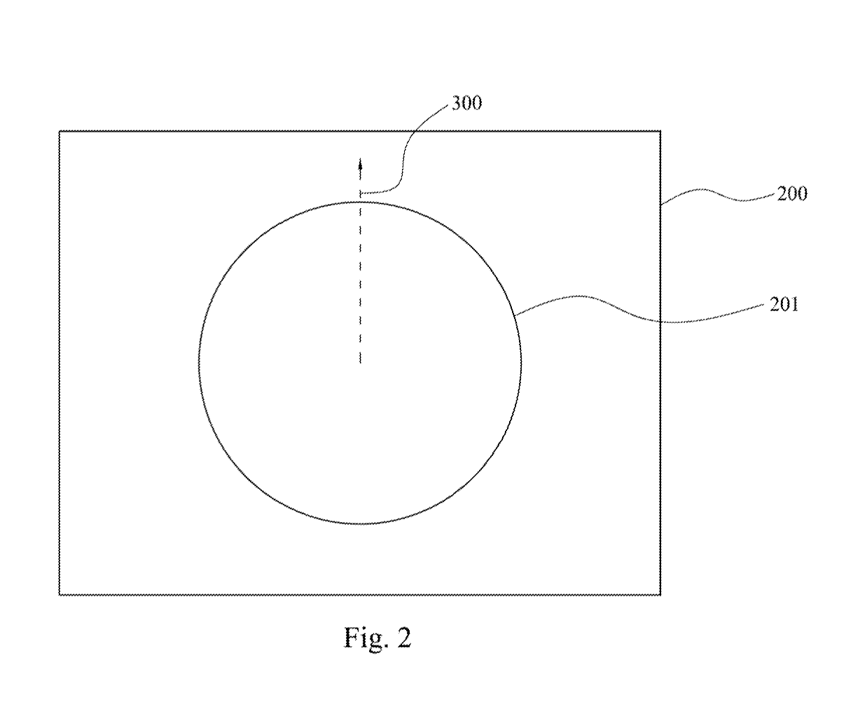

In step 150, when the drag length is not within a preset range, at least one datum of a second level is displayed on the display unit. In some embodiments, the preset range is between a first length and a second length, in which the second length is longer than the first length. Moreover, the drag track which exceeds the second length can be regarded by the processing unit as not within the preset range. Reference is made also to FIG. 2. FIG. 2 is an application of the method 100 for operating the electronic device in accordance with one embodiment of the present disclosure. In the method 100 for operating the electronic device, a function ring 201 can be displayed by utilizing a display unit 200. When the drag track 300 is sensed as being dragged from the inside of the function ring 201 to the outside of the function ring 201, it is determined that the drag length is longer than the first length, Consequently, it is easy for the user to know whether the drag length exceeds the first length and becomes within the preset range.

In some embodiments, the first level is a sublevel of the second level. In other words, the second level is a parent level of the first level. In some embodiments, the datum of the first level is a page number of a book and the datum of the second level can be an upper level in the content, for example, a chapter of the book or the name of a book in the same directory. In other embodiments, the datum of the first level is a track and the datum of the second level can be an upper level in the content, for example, the name of an album in the same directory. In other embodiments, the datum of the first level is a photo and the datum of the second level can be an upper level in the content, for example, a photo album in the same directory. Consequently, the user can remotely control or operate the user interface on the display unit to view the data of different levels on the display unit by simply performing drag operations. Moreover, in other embodiments, different preset ranges can be defined such that the data of more levels can be viewed and are not limited herein.

In some embodiments, the number of the at least one datum of the first level is plural, the number of the at least one datum of the second level is The method 100 for operating the electronic device further includes the following steps. When the drag length is within the preset range and the drag length remains the same, switch between the data of the first level (for example, switching between the page numbers of a book, switching between the tracks of an album, switching between the photos of a photo album or switching between other kinds of data of the first level) such that the switching of the data of the first level is displayed by utilizing the display unit. Consequently, when the user drags the drag track within a preset range and remains still or does not release the drag operation, the user can switch between a plurality of data of the first level. Moreover, when the user releases the drag operation, the current datum of the first level is displayed, launched, or opened such that the user can operate conveniently.

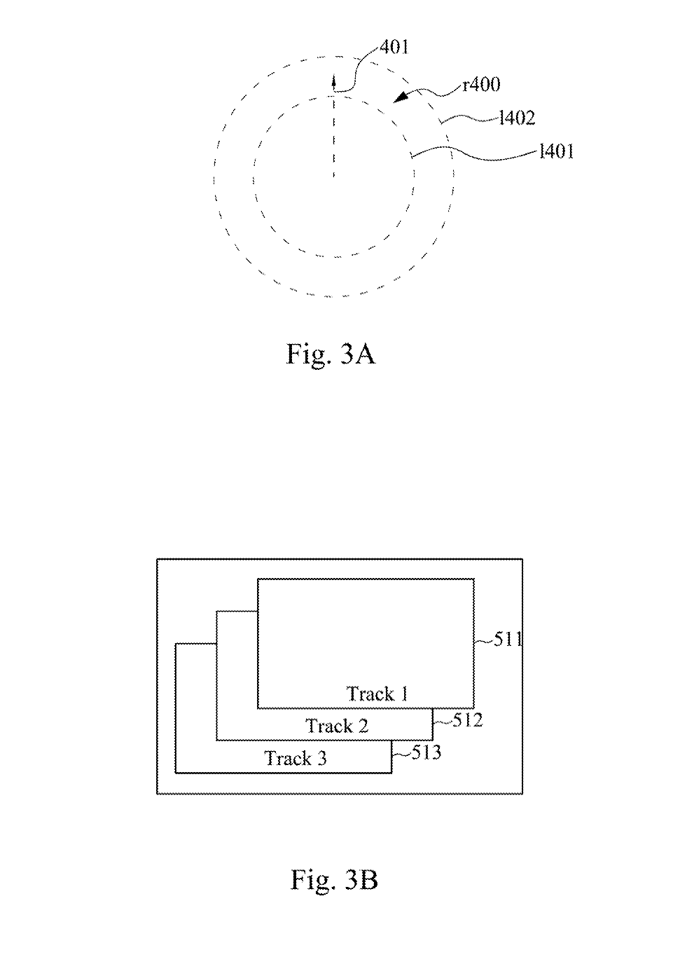

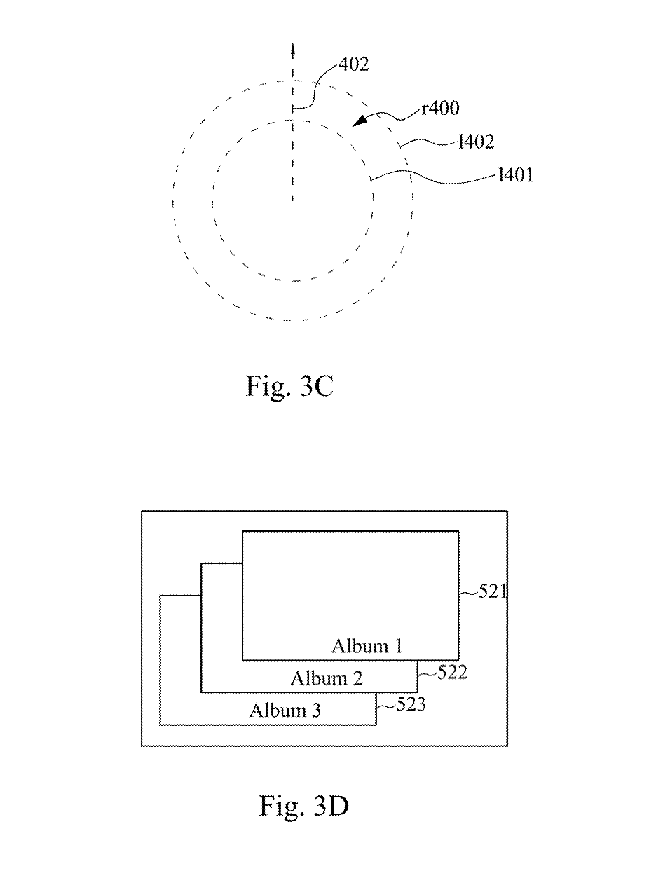

Similarly, when the drag length is not within the preset range and the drag length remains the same, switch between the data of the second level (for example, switching between the chapters of a book, switching between a plurality of book names in a directory, switching between the albums in a directory, switching between the photo albums in a directory or switching between other kinds of data of the second level) such that the switching of the data of the second level is displayed by utilizing the display unit. Consequently, when the user drags the drag track not within a preset range (for example, longer than the second length) and remains still or does not release the drag operation, the user can switch between a plurality of data of the second level. Moreover, when the user releases the drag operation, the current datum of the second level is displayed, launched, or opened. FIG. 3A to FIG. 3D are schematic diagrams of the switches between a plurality of data in accordance with other embodiments. References are made to FIG. 3A and FIG. 3B, when the drag length 401 is within the preset range r400 (i.e., the range between two boundaries I401 and I402) and the drag length remains the same, the display unit 500 displays the switch between the plurality of data of the first level (the data of the tracks 511, 512 and 513). References are made to FIG. 3C and FIG. 3D, when the drag length 402 is not within the preset range r400 (i.e., the drag length 402 exceeds the preset range r400) and the drag length remains the same, the display unit 500 displays the switch between the plurality of data of the second level (the data of the albums 521, 522 and 523). Consequently, when the user drags drag track of different lengths, the user can view the data of different levels. When the user holds the drag in the length range corresponding to the datum of the level he/she would like to view, the user can easily switch between the data of this level.

In some embodiments, drag tracks of different directions correspond to different categories of data. Therefore, a drag direction of the drag track is determined in the method 100 for operating the electronic device. When the drag direction is a first direction and the drag track is within the preset range (i.e., between the first length and the second length), display the datum of the first level belonging to a first category by utilizing the display unit. When the drag direction is a second direction and the drag track is within the preset range, display the datum of the first level belonging to a second category by utilizing the display unit.

Similarly, when the drag direction is the first direction and the drag track is not within the preset range (i.e., the drag track exceeds the second length), display the datum of the second level belonging to the first category by utilizing the display unit. When the drag direction is the second direction and the drag track is not within the preset range, display the datum of the second level belonging to the second category by utilizing the display unit. The first category and the second category can be book category, music category, photo category or other categories. Consequently, when the user performs drag operations toward different directions, the user can view the data of different levels in different categories.

In other embodiments, drag tracks toward different directions can correspond to the data of different levels of the same category. For example, when the drag direction is a first direction and the drag track is within the preset range, display the menu of the tracks of an album A of a female singer X by utilizing the display unit. When the drag track exceeds the preset range, the data of the menu of the albums in the directory of the female singer X is displayed by utilizing the display unit. Moreover, when the drag direction is a second direction and the drag track is within the preset range, display the menu of the singer directories (for example, female singer X, female singer Y and etc.) in the directory ‘female singer’ by utilizing the display unit. When the drag track exceeds the preset range, display the categorized menu (for example, ‘male singer’, ‘female singer’, ‘Mandarin’, ‘Taiwanese’, ‘English’ and etc.) in the directory ‘music’ by utilizing the display unit. However, in other embodiments, different levels can be assigned according to different categories and are not limited herein.

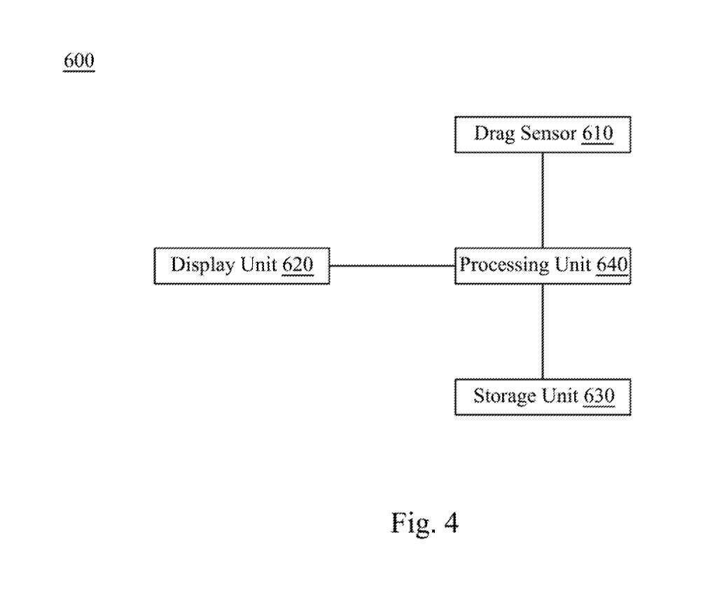

Reference is now made to FIG. 4, FIG. 4 is a schematic diagram of a system 600 for operating an electronic device in accordance with one embodiment of the present disclosure. The system 600 includes a drag sensor 610, a display unit 620, a storage unit 630 and a processing unit 640. The processing unit 640 is electrically connected with the drag sensor 610, the display unit 620 and the storage unit 630.

The drag sensor 610 can be a mouse, a touch pad, a touch panel, hardware units determining drag gestures of a user (for example, a photography unit or a G-sensor), other input units capable of providing drag functions, or systems capable of detecting or operating drags. The user can perform d operations on the drag sensor 610 such that the drag sensor 610 generates a drag track.

The storage unit 630 can be a read only memory, a flash memory, a floppy disk, a hard disk drive, a compact disc read only memory (CD-ROM), a USB memory stick, a magnetic storage device, a network accessible database or other types of storage devices. The storage unit 630 stores a plurality of instructions such that the processing unit 640 accesses the instructions stored in the storage unit 630 and execute to provide functions for the system 600.

The processing unit 640 can be a central processing unit (CPU), a control unit, a micro processor, a system on chip (SOC) or other hardware units which can execute instructions. The steps executed by the processing unit 640 can be implemented as codes such that the processing unit 640 can access the codes and execute corresponding steps.

The processing unit 640 drives the drag sensor 610 to sense a drag track. The processing unit 640 calculates a drag length of the drag track.

When the drag length is within a preset range, the processing unit 640 drives the display unit 620 to display at least one datum of a first level.

When the drag length is not within a preset range, the processing unit 640 drives the display unit 620 to display at least one datum of a second level. In some embodiments, the preset range is between a first length and a second length, in which the second length is longer than the first length. Moreover, the drag track which exceeds the second length can be regarded as not within the preset range. In some embodiments, the processing unit 640 further drives the display unit 620 to display a function ring, in which when the drag sensor 610 senses the drag track being dragged from the inside of the function ring to the outside of the function ring, the processing unit 640 determines that the drag length is longer than the first length. Moreover, when the drag sensor 610 is a touch panel, a function ring can be displayed on the touch panel to assist the user to perform drag operations such that it is easy for the user to know whether the drag length exceeds the first length.

Furthermore, the first level is a sublevel of the second level. In other words, the second level is a parent level of the first level, it can be set according to different applications. Consequently, the user can remotely control or operate the content on the display unit 620 to view the data of different levels on the display unit 620 by simply performing drag operations on the display unit 610.

In some embodiments, the storage unit 630 stores a plurality of data of the first level and a plurality of data of the second level. When the drag length is within the preset range and the drag length remains the same, a switch between the data of the first level is performed and the processing unit 640 drives the display unit 620 to display the switching of the data of the first level. Moreover, when the user releases the drag operation on the drag sensor 610, the processing unit 640 displays, launches, or opens the datum of the first level that is currently switched to.

When the drag length is not within the preset range and the drag length remains the same, a switch between the data of the second level is performed such that the processing unit 640 drives the display unit 620 to display the switching of the data of the second level. Moreover, when the user releases the drag operation on the drag sensor 610, the processing unit 640 displays, launches, or opens the current datum of the second level. Consequently, when the user drags drag track of different lengths, the user can view the data of different levels. When the user holds the drag in the length range corresponding to the datum of the level he/she would like to view, the user can easily switch between the data of this level.

In some embodiments, drag tracks of different directions correspond to different categories of data. Therefore, the processing unit 640 can determine a drag direction of the drag track. The processing unit 640 can launch different categories of data according to different drag track directions. When the drag direction is a first direction and the drag track is within the preset range (i.e., between the first length and the second length), the processing unit 640 drives the display unit 620 to display the datum of the first level belonging to a first category. When the drag direction is a second direction and the drag track is within the preset range, the processing unit 640 drives the display unit 620 to display the datum of the first level belonging to a second category.

Similarly, when the drag direction is the first direction and the drag track is not within the preset range (i.e., the drag track exceeds the second length), the processing unit 640 drives the display unit 620 to display the datum of the second level belonging to the first category. When the drag direction is the second direction and the drag track is not within the preset range, the processing unit 640 drives the display unit 620 to display the datum of the second level belonging to the second category. The first category and the second category can be book category, music category, photo category or other categories. Consequently, when the user performs drag operations toward different directions on the drag sensor 610, the user can view the data of different levels in different categories.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for operating an electronic device, the electronic device comprising a drag sensor, a display unit and a processing unit electrically connected with the drag sensor and the display unit, the method comprising:
(a) sensing a drag track by utilizing the drag sensor;
(b) calculating a drag length of the drag track by utilizing the processing unit; and
(c) when the drag length is within a preset range, displaying at least one datum of a first level on the display unit, or otherwise displaying at least one datum of a second level on the display unit.

2. The method of claim 1, wherein the preset range is between a first length and a second length, wherein the second length is longer than the first length.

3. The method of claim 2 further comprising:
displaying a function ring on the display unit, wherein when the drag sensor senses the drag track being dragged from the inside of the function ring to the outside of the function ring, the processing unit determines that the drag length is longer than the first length.

4. The method of claim 2 further comprising:
when the drag length is longer than the second length, the processing unit determines that the drag length is not within the preset range.

5. The method of claim 1, wherein the first level and the second level are different levels.

6. The method of claim 1, wherein the first level is a sublevel of the second level.

7. The method of claim 1, wherein the number of the at least one datum of the first level is plural, the number of the at least one datum of the second level is plural, and the method further comprises:
when the drag length is within the preset range and the drag length remains the same, switching between the data of the first level such that the switching of the data of the first level is displayed by utilizing the display unit; and
when the drag length is not within the preset range and the drag length remains the same, switching between the data of the second level such that the switching of the data of the second level is displayed by utilizing the display unit.

8. The method of claim 1 further comprises:
determining a drag direction of the drag track by utilizing the processing unit; and wherein step (c) further comprises:
when the drag direction is a first direction and the drag track is within the preset range, displaying the at least one datum of the first level belonging to a first category on the display unit;
when the drag direction is a second direction and the drag track is within the preset range, displaying the at least one datum of the first level belonging to a second category on the display unit;
when the drag direction is the first direction and the drag track is not within the preset range, displaying the at least one datum of the second level belonging to the first category on the display unit; and
when the drag direction is the second direction and the drag track is not within the preset range, displaying the at least one datum of the second level belonging to the second category on the display unit.

9. The method of claim 1, wherein the drag sensor is a touch panel, a touch pad, a photography unit, a G-sensor or a mouse.

10. A system for operating an electronic device, the system comprising:
a drag sensor;
a display unit;
a storage unit storing a plurality of instructions; and
a processing unit, wherein the processing unit is electrically connected with the drag sensor, the display unit and the storage unit, wherein the processing unit accesses the instructions stored in the storage unit and executes:
(a) driving the drag sensor to sense a drag track;
(b) calculating a drag length of the drag track; and
(c) when the drag length is within a preset range, driving the display unit to display at least one datum of a first level, or otherwise driving the display unit to display at least one datum of a second level,

11. The system of claim 10, wherein the preset range is between a first length and a second length, wherein the second length is longer than the first length.

12. The system of claim 11 wherein the processing unit further executes:
driving the display unit to display a function ring, wherein when the drag sensor senses the drag track being dragged from the inside of the function ring to the outside of the function ring, the processing unit determines that the drag length is longer than the first length.

13. The system of claim 11, wherein the processing unit further executes:
when the drag length is longer than the second length, the processing unit determines that the drag length is not within the preset range.

14. The system of claim 10, wherein the first level and the second level are different levels.

15. The system of claim 10, wherein the first level is a sublevel of the second level.

16. The system of claim 10, wherein the number of the at least one datum of the first level is plural, the number of the at least one datum of the second level is plural, and the processing unit further executes:
when the drag length is within the preset range and the drag length remains the same, switching between the data of the first level such that the processing unit drives the display unit to display the switching of the data of the first level; and
when the drag length is not within the preset range and the drag length remains the same, switching between the data of the second level such that the processing unit drives the display unit to display the switching of the data of the second level

17. The system of claim 10, wherein the drag sensor is a touch panel, a touch pad, a photography unit, a G-sensor or a mouse.

18. The system of claim 10, wherein the processing unit further executes:
determining a drag direction of the drag track; and wherein step (c) further comprises:
when the drag direction is a first direction and the drag track is within the preset range, driving the display unit to display the at least one datum of the first level belonging to a first category;
when the drag direction is a second direction and the drag track is within the preset range, driving the display unit to display the at least one datum of the first level belonging to a second category;
when the drag direction is the first direction and the drag track is not within the preset range, driving the display unit to display the at least one datum of the second level belonging to the first category; and
when the drag direction is the second direction and the drag track is not within the preset range, driving the display unit to display the at least one datum of the second level belonging to the second category.
